(19) United States
(12) Patent Application Publication
(10) Pub. No.: US 2006/0026032 A1
(43) Pub. Date: Feb. 2, 2006

(54) Real estate transaction system

(75) Inventors: Timothy D. Higgins, Westminster, CO (US); Michael G. Higgins, Thornton, CO (US); Michael P. Gavelek, Gilberts, IL (US); Kenneth W. Klispie, Golden, CO (US); Mark R. Sotir, Naperville, IL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SavingsStreet, LLC, Denver, CO (US)

(21) Appl. No.: 11/193,173

(22) Filed: Jul. 29, 2005

Related U.S. Application Data
(60) Provisional application No. 60/592,447, filed on Jul. 30, 2004.

(51) Int. Cl. G06Q 99/00

(52) U.S. Cl. 705/1

(57) ABSTRACT

According to the invention, a method for determining a rebate amount in a real estate purchase transaction is disclosed. In one step, viewing requests are received. From these viewing requests, the number of actual or scheduled viewings is counted. The number of actual or scheduled viewings determines the threshold. In another step, transaction data is received. The transaction data contains the purchase price and/or the agent incentive. The agent incentive is either a fee or a percentage of the purchase price. A rebate amount is calculated from the threshold and the transaction data. The rebate amount is then provided to a user.

### CROSS-REFERENCES TO RELATED APPLICATIONS

This application claims the benefit of U.S. Provisional Application No. 60/592,447 filed on Jul. 30, 2004, which is incorporated by reference in its entirety for all purposes.

### BACKGROUND OF THE DISCLOSURE

This disclosure relates in general to real estate transactions and, more specifically, but not by way of limitation, to commission structures for real estate transactions.

In a real estate transaction, there are typically two agents or brokers—one representing the seller, and one representing the buyer. These agents often contract to work on a commission, which is usually related to the sale price of the real estate. For real estate that includes residential dwellings, the rate is generally in the 5%-7% range. Other types of transactions, such as industrial or commercial real estate have a range of commission rates that is standard for that type of transaction.

The commission is typically divided between the seller's agent and the buyer's agent. The buyer's agent's portion of the commission is commonly referred to as the “co-op fee,” while the seller's agent's portion of the commission is commonly referred to as the “listing fee.” A seller's agent's costs are typically more static, since they include necessary expenses such as entry into a Multiple Listing Service (“MLS”) and appraisal costs. In contrast, a buyer's agent's costs can vary greatly.

For example, a prospective buyer may have done research and already knows the particular house they want to buy. In other cases, a prospective buyer may have researched a particular neighborhood. In still other cases, a prospective buyer may have done no research. Each of these situations will have different time requirements of the buyer's agent.

### BRIEF DESCRIPTION OF THE DRAWINGS

The present disclosure is described in conjunction with the appended figures:

FIG. 1 is a block diagram of an embodiment of a real estate system;

FIG. 2 is a flow chart showing an embodiment of the buying process;

FIG. 3 is a flow chart showing an embodiment of the selling process;

FIG. 4 is a screenshot showing an embodiment of the initial user information collection screen;

FIG. 5 is a screenshot showing an embodiment of a more detailed user information collection screen;

FIG. 6 is a screenshot showing an embodiment of buyer's interface screen;

FIG. 7 is a screenshot showing an embodiment of a scheduling screen;

FIG. 8 is a screenshot showing an embodiment of the property listings screen; and

FIG. 9 is a screenshot showing an embodiment of the property search screen.

In the Figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE PREFERRED EMBODIMENT

An embodiment of the present invention provides a method for generating rebates to real estate buyers. Depending on the criterion, a buyer may be entitled to a rebate on the purchase price of the real estate. Embodiments of the present invention may evaluate various factors to determine whether a buyer is entitled to a rebate. As examples that are not intended to be limiting, the factors considered may be number of homes shown, the buyer's prequalification for mortgage and the price of the home. An alternate embodiment may vary the size of the rebates based on an evaluation of factors.

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, structures and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order o the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

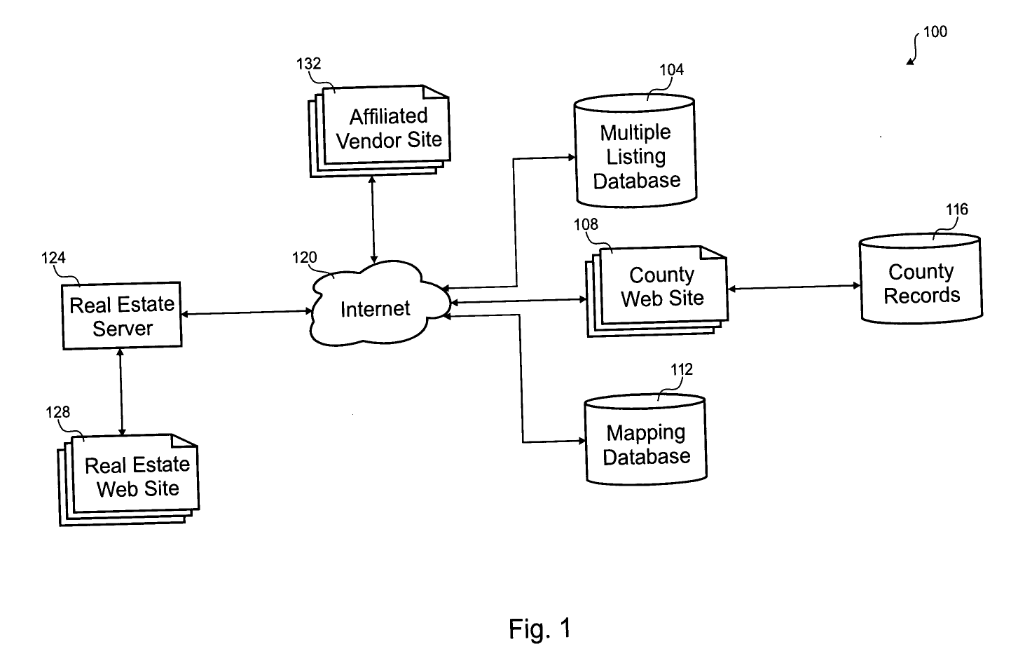

Referring initially to FIG. 1, an embodiment of an real estate system 100 is shown in block diagram form. The real estate system 100 is used by buyers and sellers during the purchase or sale process. The main interface of the buyers and sellers is a real estate web site 128 that allows searching using a multiple listing service (MLS), completing various forms, educating the clients, and gathering status information. A real estate server 124 runs the real estate web site 128 and is connected to the Internet 120 or some other wide area network. The real estate web site 128 is linked to affiliated vendor sites 132, but presented to the buyers and sellers with varying levels of integration with the real estate web site 128.

The real estate web site 128 may have access to a number of MLSes for the various geographic regions supported by the real estate web site 128. In this embodiment, a multiple listing database 104 is regularly updated with information from the various MLSes. The frequency of update and process varies from MLS to MLS. In some cases different MLSes have different information fields and formatting. The updates are reformatted such that the multiple listing database 104 can use common fields and formatting.

The affiliated vendor sites 132 are screened in this embodiment and provide the various services that a user might use during the process. In addition to vendor sites 132, links to vendor search engines could be included. To find a painter, for example, three affiliated painters could be shown with links to their web site. Additionally, the residential painter portion of the geographically relevant yellow pages directory could be included. The real estate web site 128 could have the ability for users to comment on particular vendors in order to rank them for the benefit of other users.

When researching listings, the users have the ability to map those listings. A third-party mapping database 112 is used in this embodiment to provide maps for any selected area. The real estate web site 128 has the ability to map a number of property locations on a single map. The various properties to display are analyzed to determine their relative location. A map size is chosen that includes all properties to map. A zoom level is chosen such that the map fits in a frame or window on a web page.

The real estate web site 128 in some embodiments has the ability to gather information from other web sites and databases. This additional information could include property tax information, prior sale history, permit information, neighborhood information, statistics on the neighborhood, etc. In this embodiment a county web site 108 is linked to by the real estate web site 128 such that a user can research the county records 116. The other web sites and databases are tied to a geographic location of interest to the user or to a particular property. Some embodiments may gather information from these other web sites and databases for presenting at the real estate web site 128.

Threshold Triggered Commission

A buyer's agent to a real estate transaction is customarily paid a commission by the seller called a co-op fee. In some cases, this co-op fee is 2.8% of the sale price of a transaction, but can vary. In the invention, the co-op fee is partially rebated to the buyer after the transaction closes or some later triggering event. The amount of the rebate is generally tied to the number of home viewings requested by the buyer from the buyer's agent. As more viewings are preformed, the rebate generally decreases. One embodiment has three thresholds for the number of viewings (e.g., 10, 20, and 30) to provide three different rebate percentages (e.g., 36%, 18% and 9% of the co-op commission), but any percentage and number of thresholds could be used in various embodiments. The three rebate percentages could be capped at some percentage of the sale price (e.g., 1%, 0.5% and 0.25%) for the various thresholds. More expensive houses could have a different set of thresholds and percentages, for example, those $150,000 and above. Some embodiments could use a rebate or could reduce the offer commensurately with an explanation that part of the co-op fee is being waived.

The rebate isn't actually paid until a survey is completed in one embodiment. The survey can be used to gather testimonials. Other embodiments may require other steps be performed before the rebate is paid.

Rebate is available to buyers who close escrow/proceed to final settlement with the buyer's agent (i.e., the procuring cause or referring source) for the purchase of real estate. In this embodiment, the amount of the rebate is determined by the final sales price of the home purchase for resold homes and the final base price of new construction, the number of unique property showings requested by the home buyer and the “co-op” commission offered by the listing or seller's agent. All home buyers in the program agree to complete all electronic post property showing surveys, an electronic post-settlement survey for their purchased property, agree to receive offers from partners companies and advertisers, and grant the buyer's agent the right to use their name in customer testimonials for a period of one year.

The below table is used in one embodiment to determine the specific amount of a rebate provided to the buyers participating in the program. In different embodiments, the percentages, threshold showings, number of showing thresholds, threshold amount, number of amount thresholds, rebate caps, etc. can be changed.

| | Number of | Your Percentage Rebate |
|---|---|---|
| Sales Price | Showings | of the Broker Co-op Fee |
| $0-$74999 | N/A | 0% |
| $75,000-$149,999 | 1-10 | 36% |
| | | (Not to exceed 1% |
| | | of Purchase Price) |
| $75,000-$149,999 | 11-20 | 18% |
| | | (Not to exceed .5% |
| | | of Purchase Price) |
| $75,000-$149,999 | 21-30 | 9% |
| | | (Not to exceed .25% |
| | | of Purchase Price) |
| Over $150,000 | 1-10 | 71% |
| | | (Not to exceed 2% |
| | | of Purchase Price) |
| Over $150,000 | 11-20 | 36% |
| | | (Not to exceed 1% |
| | | of Purchase Price) |
| Over $150,000 | 21-30 | 18% |
| | | (Not to exceed .05% |
| | | of Purchase Price) |

In the above table, the sales price is the final sales price of the property at closing. The number of showings is the maximum number of unique property showings scheduled by the real estate buyer. Where a property is shown an number of times, all the showings count as only one unless the buyer asks to see the same property more than three times. Should the buyer fail to show-up at a scheduled showing or find a home to buy before attending the showing, the scheduled showing is counted anyway. In other embodiments, showings canceled a reasonable time period before the showing would not be counted. The broker co-op percentage fee is the part of the sale price allocated by the seller for the cooperating broker (i.e., buyer's broker) who represents the home buyer.

The embodiment in the above table is further explained with two examples. In a first example, the buyer purchases a $225,000 home and the real estate firm refers your name to an affiliated real estate agent or transaction broker participating in the program. The buyer has fulfilled all the other requirements of the program. It is the 8th unique property the buyer has requested a showing for, and the buyer has requested a total of ten unique property showings. It could be that two of the properties were viewed twice, but the second viewing of each would not count. The seller has offered a 2.8% cooperating broker commission. The buyer would receive $4,473.00 from the real estate firm after a successful final settlement.

In another example, the buyer is purchasing a $225,000 home and the real estate firm refers the buyer's name to the listing agent. It is the 8th property the buyer requested a showing for, but the buyer has requested a total of twelve unique property showings (the buyer has not actually physically visited all twelve properties yet). The seller has offered a 2.8% cooperating broker commission. The buyer would receive $2,268.00 from the real estate firm after the successful final settlement.

In one embodiment, rebates for new construction purchased directly from a builder/developer is treated differently. In the event that the real estate firm registers you as a buyer with a builder/developer, the builder/developer will often pay the real estate firm a referral, cooperating broker, finder's fee, or other type of compensation at close of escrow/final settlement. The exact amount of compensation received by real estate firm will vary based on the particular builder/developer. Be advised, many builders/developers require that an agent of the buyer must personally accompany a prospective buyer to the development on the buyer's first visit for the agent to be entitled to receive any compensation. Rebates for new construction follow the same terms outlined above, but could be different in some embodiments or could vary based upon the terms offered by the particular builder/developer.

In one embodiment, the real estate agency relationship with the buyer can take multiple forms. For example, the buyer may have the option of the realtor being a Buyers Agent or a Transaction Broker as those agency relationships are defined under state law. Depending on the duties and liabilities of these different types of realtors, the rebate, percentages and number of showing thresholds may be adjusted.

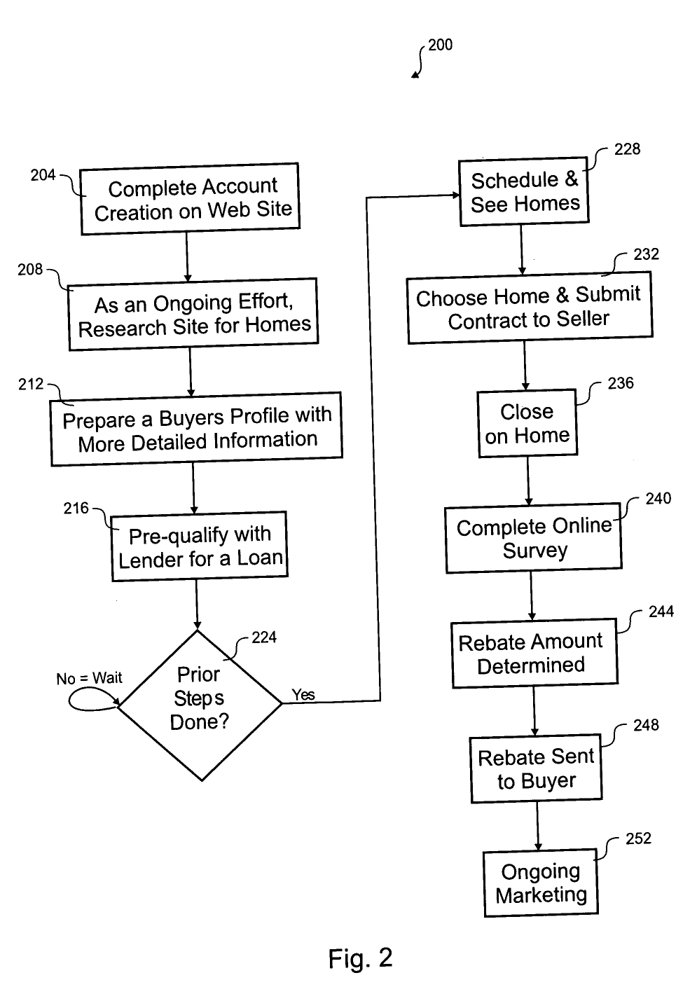

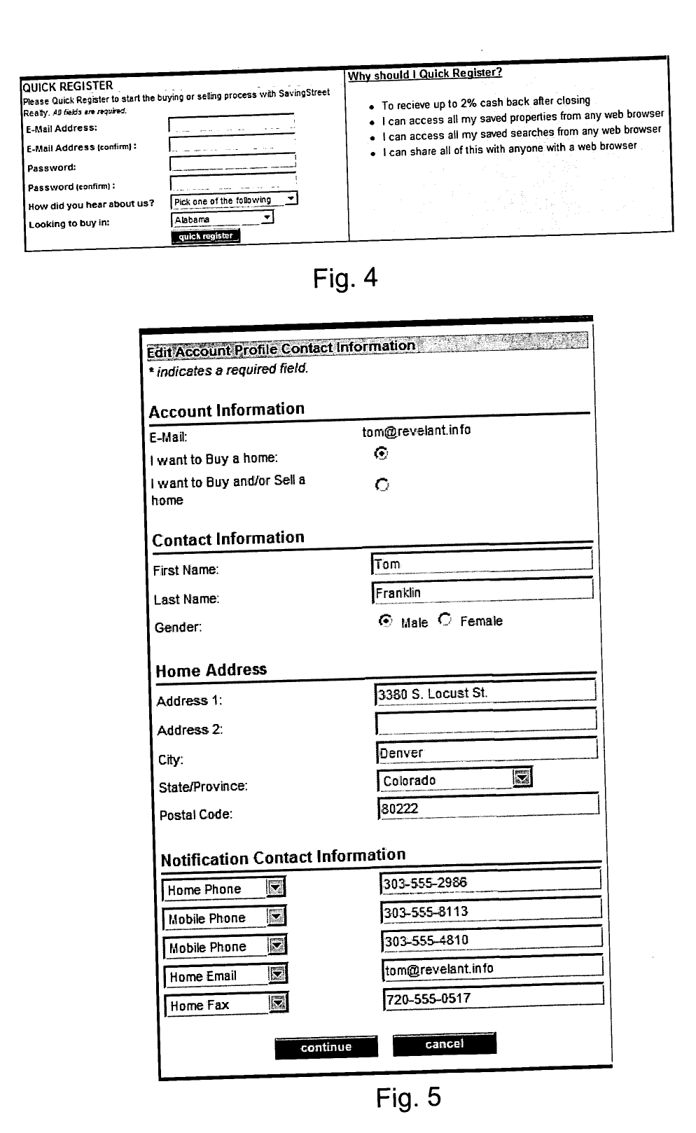

Referring to FIG. 2, an embodiment 200 of a flow diagram showing the buying process is shown, which demonstrates the rebate program. Steps 204, 208, 212, and 216 are completed before a showing can be scheduled, but so long as step 204 is performed first, the remaining steps 208, 212 and 216 can be performed in any order. Step 204 involves creating an account with the real estate web site 128 that has a minimal amount of information such as geographic area, a login name and a password, but could also include name, e-mail address, and referral source. An embodiment of the screen shot for entering this information from step 204 is shown in FIG. 4. More detailed information is entered in step 212. A screen shot of the form for completing step 212 is shown in FIG. 5. Some embodiments could require more or less information to complete step 212, but this step at least includes contact information if not already provided in step 204.

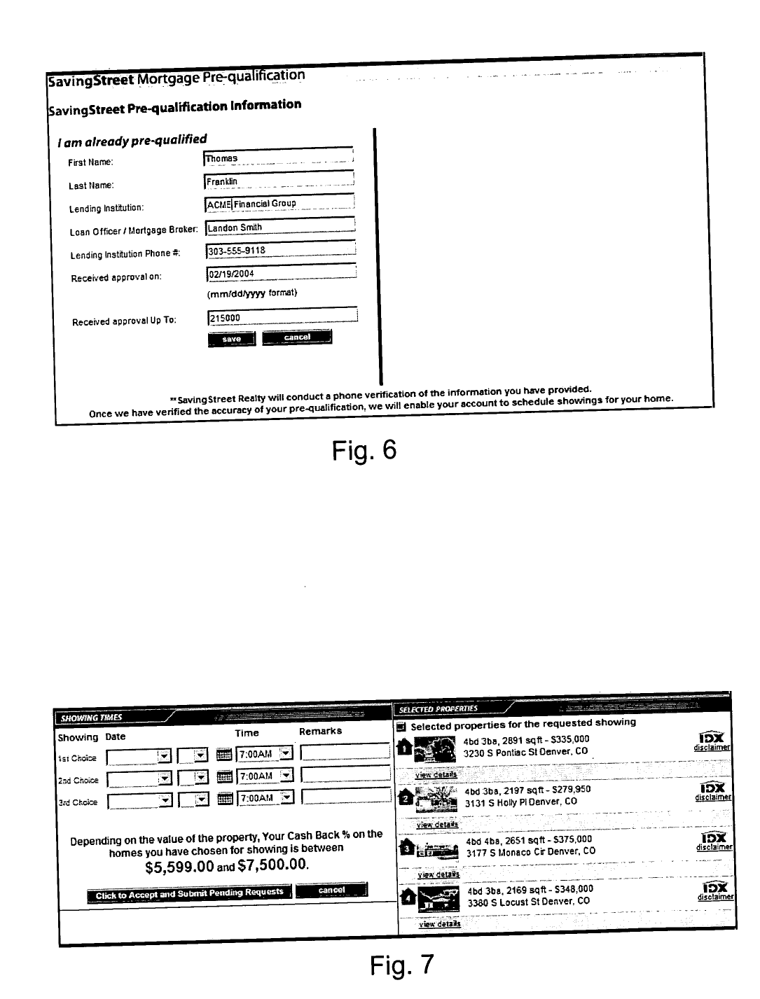

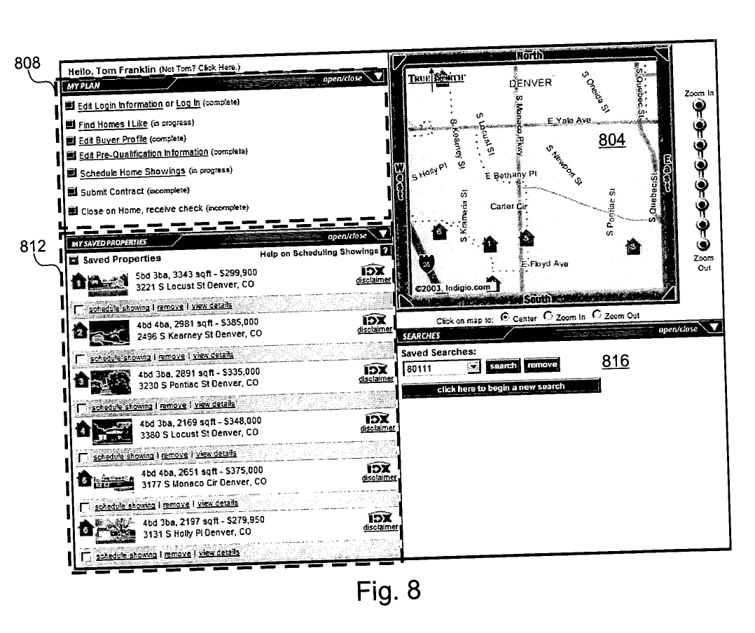

Before passing step 224, prequalification is performed in step 216. The buyer may choose to use any lender or loan broker or choose an affiliated one listed on the real estate web site 128. Those listed on the web site 128 may have online forms in their affiliated web site 132 to allow qualification. These affiliated lenders/brokers can report back to the real estate web site 128 with information when this step is complete. The plan status 808 shown in FIG. 8 is updated when the buyer logs in next time. The buyer is also given the ability to manually enter the relevant information of the prequalification. An embodiment of this entry form is shown in FIG. 6. Some embodiments may allow the user to fax, upload a copy of the qualification from the lender. In other embodiments, the validity of the entry form information may be manually verified with the lender or loan broker.

Once the preliminary steps are completed, the buyer can use the real estate web site 128 to schedule home viewings in step 228. As an ongoing process, the buyer is researching the multiple listing database 104 in step 208 to find prospective properties. FIG. 7 shows a scheduling screen. Any number of properties can be selected before a few possible viewing periods are selected by the buyer. In the depicted embodiment, four houses are selected for viewing and the buyer can put in up to three times that might work for the viewing. Steps 208 and 228 are repeated until a home is found.

In step 232, a home is chosen and a contract is submitted to the seller 232. The seller may not accept the offer or the house may fall out of escrow, but if there are no problems, the house is closed upon in step 236. The buyer fills out the online survey in step 240. Once that is complete, the rebate amount is determined in step 244 and sent to the buyer in step 248. Ongoing marketing to the buyer may occur for a period of time. Advertisers that are selling products and services to new home buyers could send e-mail and mail to the buyer. Also, any testimonials could be used on the real estate web site 128 or in advertising for that site 128.

Seller-Side Real Estate Transaction

Generally, the more the seller does to sell the house, the larger the rebate offered to the seller. A sale assessment of the property could be performed by a stager, the seller's agent or a sales consultant, for example. Problems noted could be fixed by the seller and refunded as a rebate when the property sold. The amount of the rebate could be capped at a percentage of the commission offered to the real estate firm. For example, a 5.8% commission may be offered to the real estate firm handling the sale. A co-op fee of 2.8% would be paid to the buyer's agent. The rebate could be limited to half or a third of the remaining 2.8%. Some embodiments could simplify the offering by making the cap a fraction of the total commission paid, for example, the 5.8% commission.

In one embodiment, the percentages could vary with the price of the house. For example the rebate cap is 20% of the total commission for houses less than $200,000 or some other threshold, but 35% of the total commission for houses over $200,000. The percentage be different for any number of thresholds. In one embodiment, the percentage is scaled between one or more ranges. For example, the commission could vary between 25-50% over the $1-2 million price range.

In one embodiment, beyond capping the rebate to a fraction of commission of the seller's real estate firm, the rebate is further limited to a fraction of what is spent in fixing the issues raised in the sale assessment. This percentage could be any integer between in the range 50-100%. For example, one embodiment could pay 50% of all fixes should that amount not exceed 20% of the total commission. Some embodiments could pay a different fraction of the remedial fixes that varies with the sale price. There could be any number of sale price thresholds or scaling for ranges to adjust the percentage reimbursed.

In another embodiment, the rebate could be tied to the time on the market. The quicker the sale, the larger the rebate. The percentage of the total commission could start at some value and shrink over time. For example, the percentage could be 20% of the total commission initially, but drop to 10% after three months. Interpolation could be used to determine the percentage within the three month period. There could be any number of thresholds in some embodiments where the percentage changes. For example, the percentage could be 20% for the first month, 15% for the second, 10% for the third, and 5% for the fourth.

The seller real estate firm commission could be tied to several different packages of service offered the seller. With a higher commission, more is offered to the seller. For example, the seller's commission could scale from 1% to 2.8% based upon the package of services chosen by the seller. At 1%, the seller would get up to 10 hours of a first service, up to 5 hours of another service, etc. At 2.8%, the seller would get up to 40 hours of a first service, up to 25 hours of a second service, etc. For example, at 1% the seller could get 10 hours of time to get the house on the market, 5 hours of support while on the market, 10 hours while the house is under contract, and 4 hours to attend to closing issues. Additional hours could be paid for in cash or by increasing the seller's commission by a dollar amount.

In another embodiment, the aggregate hours could be offered for the various commissions made available to the seller's agent. One percentage commission could correspond to a number of hours available for whatever task the seller wants performed. For example, a 1% commission may entitle the seller to 29 hours of service throughout the process, but a 2.8% commission may entitle the seller to 100 hours of service. The seller can choose to use the hours however they please.

In one embodiment, the seller uses hours however they please but as the hours are used, the commission increases between a range. There could be thresholds or interpolated increases in the commission as the hours are consumed.

In one embodiment, a minimum listing fee is defined that the seller's commission cannot fall below regardless of the percentages and other calculations. In one embodiment, the minimum listing fee is $2,000 plus an agreed upon cooperating brokerage fee to be paid to a cooperating broker (i.e., a broker or agent who brings the successful buyer). The market rate for the cooperating brokerage fee may vary based on local custom and market conditions.

However the commission is configured, determined or changes, the real estate web site 128 would reflect the current plan, percentages and commission available to the seller. As the commission changes over time, so would the real estate web site 128 update to reflect the change. Also, problems noted by the sale consultant could be listed online with optional vendors to fix particular issues. As the issues are completed, the amounts spent on the fixes could be displayed and their qualifying reimbursement amount in any rebate. The vendors affiliated with the real estate firm could enter the amounts spent or the seller could submit receipts or otherwise have the seller agent confirm the expenditures.

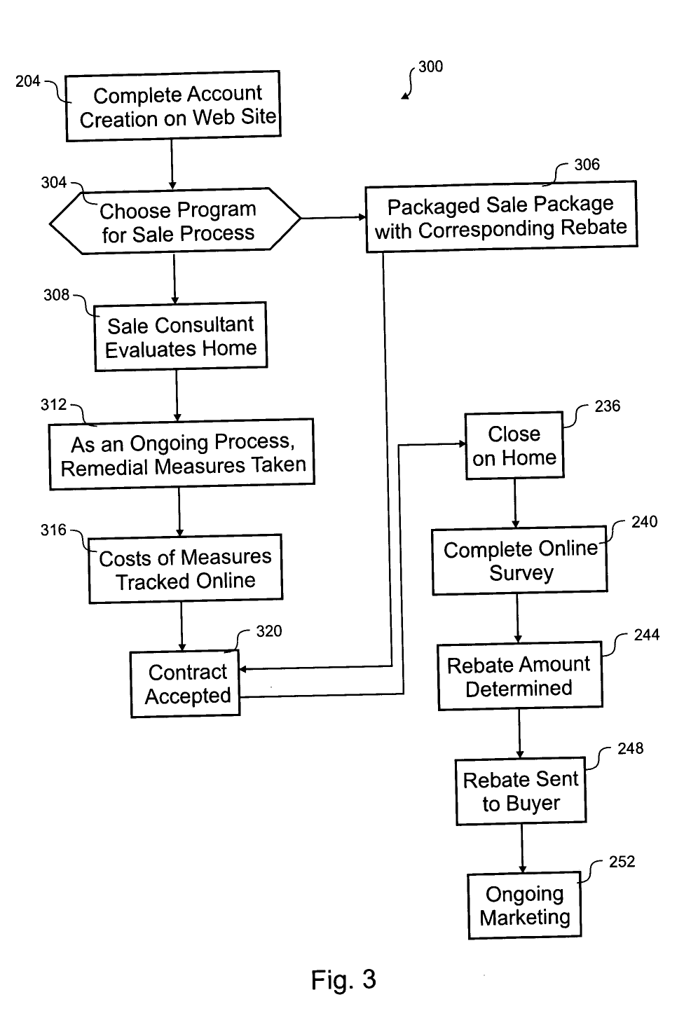

FIG. 3 shows one embodiment of a process 300 for the seller to participate in the rebate program. After an account is created in step 204 (see screen shot in FIG. 4), the seller chooses a rebate program in step 304. Some embodiments may not offer a choice and just offer one program or another. The seller may choose a packaged sale package in step 306 with predetermined services or hours of service defined for a particular rebate.

Alternatively, the seller can choose to have a sale consultant evaluate the house in step 308. The problems and suggested improvements are acted upon in step 312 as an ongoing process while on the market. The seller and/or vendors can enter the costs incurred in step 316. In step 320, a contract from a buyer is accepted. Processing continues through the same steps 236, 240, 244, 248, and 252 as FIG. 2 until the process 300 is complete.

System for Scheduling Real Estate Viewing by Qualified Buyers

Often buyer do not clearly understand the price of house that can be afforded. A buyer's agent can perform showings where a buyer could not qualify for a loan to pay for the house. Further, some buyers never seriously intend to buy a house and take advantage of a buyer's agent who might perform showings without a chance of earning a commission. A screening factor for these situations is requiring a buyer that has a lender letter qualifying them to purchase a house of a particular amount. The system for scheduling showings requires pre-qualification from an associated lender or any other lender.

The potential buyer can view information on houses for sale and perform other research, but cannot use the system for scheduling showings until the pre-qualification form on the web site is completed. This pre-qualification is illustrated in FIG. 2. Step 216 must be completed before step 224 will allow proceeding to step 228 where a home showing can be scheduled. Conventional realtors waste much of their time with buyers who couldn't qualify to purchase a home that they might want to view. Additionally, some curious individuals pose a interested buyer just to see a particular house with no serious intention to buy. The link to schedule a showing is not active for the user of the real estate web site until the pre-qualification form shown in FIG. 6 is successfully completed and verified.

Multiple Property Information and Mapping Display

When viewing real estate for sale, conventional systems can display a map showing the location of a single property. This may be done on a web page or in a pop-up window. In one embodiment, multiple properties are shown together on a single map along with other information. FIG. 8 shows an embodiment of this invention as a real estate dashboard, which includes a plan status portion 808, a selected property portion 812, a multi-property map 804, and a search portion 816. The search portion 816 is used to do various searches, which can be saved, in order to choose various houses that are stored in the selected property portion 812. Rebate requirement progress is shown in the plan status portion 808.

Homes in the selected property portion 812 and those displayed in various searches include an indication (e.g., icon, number, coloring) of those that qualify and/or an indication of the percentage of co-op fee offered by the seller. The indication can help the buyer stay on plan for the expected rebate as some properties may not be eligible. A dollar amount could be displayed in some embodiments that shows the projected rebate for each property if there were a closing on that property at the listed price without further viewings.

Various embodiments could combine the multi-property map 804 with corresponding property listings 812 and other optional information. The embodiment of FIG. 8 shows these items 804, 812 with the plan status portion 808 and a search portion 816, but other embodiments could include portions with information on the status on scheduling showings, a showing calendar, advertising, real estate buying tips, etc.

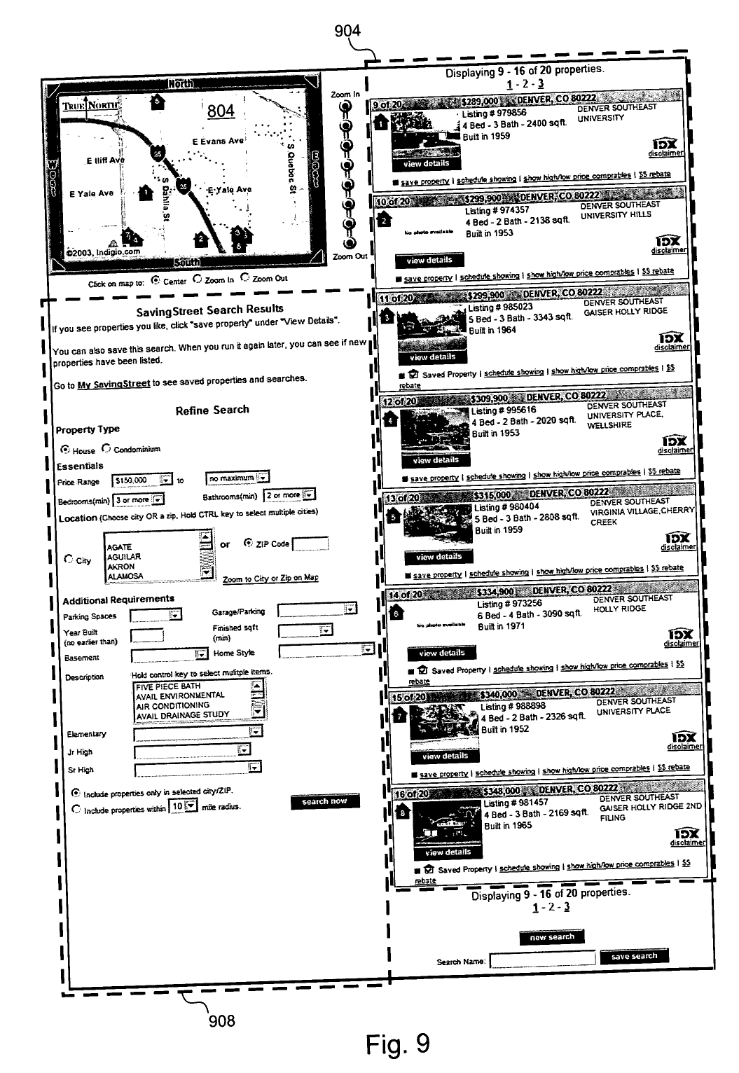

In the embodiment of FIG. 9, a search page is shown. The search page has at least some of the properties meeting the search criteria on a property listing portion 904 of the search page. There is also a multi-property map 804 on the page showing the location of the properties from the property listing portion 904. Numbers, icons and/or symbols are used to correlate the properties to the map 804.

This embodiment optionally includes a search criteria form 908. This form 908 lists the current search criteria used to produce one or more pages of properties in the property listing portion 904. The buyer can modify the search criteria and re-run the search. Once satisfied with the search results, the search criteria in the form 908 can be saved under any name.

Real Estate Client Information

Different databases could be pulled together to improve the information to clients. For example, the county records showing past sale, tax and permit information could be presented. Conventional web sites only show MLS data that is screen in various ways. The municipalities information, average sale price, past sale information, neighborhood statistics and other information could be gathered and added to the multiple listing database 104 for each home in the MLS. Some embodiments could gather this information in real-time after a request to view the information has been made by a user.

Marketing to Client List

Various mailings could be performed to the users of a real estate web site. For example, builders could send messages with current offerings. New properties offered by the real estate system 100 could be sent to all users on the list along some sort of a special discount or rebate for the buyer. The discount could only be available if the buyer takes advantage of the offer quickly using an real estate agent affiliated with the system 100 (i.e., an affiliated agent). In one embodiment, the seller could get an additional rebate when the sale is to a buyer represented by an affiliated agent.

Affiliated vendors also have the ability to market to the user list both during and after the sale. With authorization by the user's, certain information could be provided to these vendors to allow marketing efforts applicable to the individual users. For example, once a contract is entered into the buyer or seller could receive e-mail advertising from moving companies. These advertisements could be separate from the normal communication with the system 100 or integral with the presented web pages and e-mail.

Real Estate Transaction Specialists

In this embodiment, the real estate transaction is broken down into stages that could be delegated to different parties affiliated with the system 100. You could have a showing specialist, offer specialists and closing specialists. The specialist does this task and becomes an expert and may have different professional training. A client may interact with any number of professionals throughout the real estate transaction. In one embodiment, the scheduling agents who set appointments for showings could be located in a call center to set up showings for whole company despite being geographically separated from the users. The closing specialist could be an attorney or contracting officer.

Online Real Estate Scheduling System

A difficult task for buyers agents is the scheduling of viewings with their buyers. Often scheduling is done manually with a phone call to the buyers agent who then phones the various seller's agents, but buyers agents are very busy. The chosen houses to view are individually displayed in a selected property portion 812 for each buyer as a list of properties that they have selected from a search process. The real estate web site 128 allows a buyer to specify three dates/times that they would like to view one or more houses from their personalized list as shown in FIG. 7.

Other embodiments could have more complex time scheduling ability. A calendar of free times for the agent could be known to the real estate web site 128 such that the buyer could only select times that are available in their affiliated agent's schedule. Additionally, selected properties may have certain scheduling requirements that could be used to filter what time the buyer can choose. For example, a particular property only allows viewings on weekends such that the buyer could only select showings for the weekend. In some cases, the showing schedule for some or all houses could be available to the real estate web site 128 such that the possible scheduling times could be further screened by actual availability if it can be automatically determined.

Once times are selected, a message is sent to the buyer's agent or to a dispatch center to find an agent. After checking availability, the buyer's agent chooses the best time by referring to their schedule and house availability. This can be automated as discussed above when the agent and/or house(s) already have their schedules entered electronically. Where none of the times are available, a status page could reflect that the buyer should pick new times and they could be notified by e-mail. The buyer and/or agent can accomplish this scheduling over e-mail messages or through a status page on the web site. As the individual houses are scheduled, the real estate web site 128 can be updated with actual times. The user can accept or reject the scheduling using the real estate web site 128. Once a plan is agreed upon, a package showing directions, maps, house information can be downloaded from the web site or sent to the user by e-mail.

Agent Routing for Serialized Showings to Multiple Clients

Routing a real estate agent to multiple viewings around town for various clients is a difficult problem. Clients input their three best times for viewings in one embodiment and specialized showing agents fulfill those requests in this embodiment. These requests are gathered from multiple clients and houses taking into account availability of the houses and showing agents. If not available electronically, the prospective houses are contacted for viewing times available. A route and timing is proposed for an agent or agents to service the various viewings. The buyers can view the proposed schedules on the web site and accept or reject the proposals. As the proposals are accepted and rejected, the routing is constantly being updated to make the most efficient use of the showing agents. The travel times are taken into account when choosing the proposals. Generally, the same showing agent is used for a particular buyer viewing multiple homes if that is possible.

Once the proposals are accepted, the routes are finalized. Each buyer is sent a package the lays out the houses and directions between them. The agents could have a handheld device (e.g., PDA with Internet or blackberry devices) that can handle scheduling in real-time. Additionally, these handheld devices could have location determination capability to know their current location. A package is sent to each showing agent that lays out the route and house information. This package can use any tracking capability of the handheld device to show movement throughout the plan. The scheduling center can be updated with agent locations such that buyers can be informed if an agent is running late or if there is any other problem.

Affiliated Broker Arrangement Automation

On the buyer side of the transaction, the buyer must find a mortgage company or broker and pre-qualify before any showings of houses occurs. In some embodiments, a mortgage company or broker is tied into the real estate web site 128 and the buyer can optionally use that mortgage company or broker. The real estate web site 128 could include forms to gather additional information for the loan application process. The information in the form could be used by the mortgage company or broker to pre-qualify the buyer and ultimately complete the purchase with a loan. The status of the loan process could be reflected on various pages of the real estate web site 128.

There could be certain incentives offered to buyers from the affiliated mortgage company or broker. These incentives could be in the form of cash or increased rebates. In one embodiment, the additional information for the loan application process can be sold by the real estate web site 128 for a fee to various mortgage companies or brokers who can present loan offers to the buyer. These offers could be updated according to current interest rates and would have the benefit of detailed loan information such that the offers can be more accurate than general quotes that don't apply to some buyers. A web page on the real estate web site 128 could have status on the loan process along with current quotes for the buyer.

Affiliated Title Insurance Automation

On the seller side of the transaction, a title insurer is often chosen to provide the title insurance. The sale contract presented by the buyer may specify a particular title insurer to use. The real estate web site 128 could gather the information requested by the title insurer and provide that for a fee in situations where the buyer or seller use an affiliated title company. Gathering the information on the parties and property and providing it to the title company eases the process. Additional forms on web pages could be presented to the buyer or seller to gather additional information that the title company may request. Any previously gathered information stored at the real estate web site would be used when available to ease the burden on the buyer or seller.

Multi-Agent Open House Automation

When performing open houses, seller agents often operate independently of other agents when scheduling, planning and advertising these open houses. Today, prospective buyers cannot go to multiple open houses in any organized manner. In one embodiment, a number of open houses are coordinated even though the houses are offered by different agents. The times are coordinated along with print and online advertising. Prospective buyers considering a certain part of town to buy a house could see advertising that shows a coordinated open house event.

A web site could show a map of all the open houses, could route between a select number of them, provide property information, and directions through a path that includes all the properties selected by the buyer. The path could take into account varying times that each house might be open. Contact information could be provided to all the seller agents after a trip is planned by a buyer or after the day of the open house event.

All the seller agents could try to represent the prospective buyers that are not already represented by an agent. The order in which the properties are listed for a coordinated event could be random or positioning preferences for listing and routing could be sold to the seller agents. Incentives could be offered to buyers who choose a house after participating in an open house event. The incentive could be larger if the buyer was not represented by an agent.

Although the above embodiments speak in terms of residential real estate, the invention is extendible to commercial real estate, raw land and other similar transactions.

While the principles of the invention have been described above in connection with specific apparatuses and methods, it is to be clearly understood that this description is made only by way of example and not as limitation on the scope of the invention.

What is claimed is:

1. A method for determining a rebate amount in a real estate purchase transaction, wherein a purchased property has a purchase price and an agent incentive, the method comprising the steps of:
receiving a plurality of viewing requests;
counting a number of actual or scheduled viewings, wherein the actual or scheduled viewings are initiated by one of the plurality of viewing requests;
determining when the number of actual or scheduled viewings reaches a threshold, wherein the threshold is a predetermined number of actual or scheduled viewings;
receiving transaction data, wherein the transaction data comprises at least one of the purchase price or the agent incentive, wherein the agent incentive is at least one of a fee or a first percentage of the purchase price;
calculating a rebate amount, wherein the rebate amount is a function of the determining step and the transaction data; and
providing the rebate amount to a user.

2. A computer readable medium having computer executable instructions for performing the computer-implementable method for determining a rebate amount in a real estate purchase transaction, wherein a purchased property has a purchase price and an agent incentive of claim 1.

3. A computer system adapted to perform the computer-implementable method for determining a rebate amount in a real estate purchase transaction, wherein a purchased property has a purchase price and an agent incentive of claim 1.

4. A computer data signal embodied in a carrier wave having computer-executable instructions for performing the computer-implementable method for determining a rebate amount in a real estate purchase transaction, wherein a purchased property has a purchase price and an agent incentive of claim 1.

5. The method for determining a rebate amount in a real estate purchase transaction of claim 1, wherein the rebate amount is at least one of a second percentage of the purchase price or a monetary amount.

6. The method for determining a rebate amount in a real estate purchase transaction of claim 1, wherein the user is an agent associated with the agent incentive.

7. The method for determining a rebate amount in a real estate purchase transaction of claim 1, wherein the threshold is one of a plurality of thresholds, each of the plurality of thresholds corresponding to a different predetermined number of actual or scheduled viewings.

8. The method for determining a rebate amount in a real estate purchase transaction of claim 7, wherein each of the plurality of thresholds corresponding to a different predetermined number of actual or scheduled viewings corresponds to a rebate amount.

9. The method for determining a rebate amount in a real estate purchase transaction of claim 1, wherein the agent incentive is reduced by the rebate amount.

10. The method for determining a rebate amount in a real estate purchase transaction of claim 7, the number of thresholds is less than the number of actual or scheduled viewings.

11. The method for determining a rebate amount in a real estate purchase transaction of claim 1, wherein the agent incentive comprises a sales commission.

12. A method for determining a rebate amount in a real estate purchase transaction, wherein a purchased property has a purchase price and an agent incentive, the method comprising the steps of:
receiving a plurality of viewing requests;
counting a number of actual or scheduled viewings, wherein the actual or scheduled viewings are initiated by one of the plurality of viewing requests;
determining when the number of actual or scheduled viewings reaches one of a plurality of thresholds, wherein each of the plurality of thresholds corresponds to a different predetermined number of actual or scheduled viewings;
receiving transaction data, wherein the transaction data comprises at least one of a purchase price or an agent incentive, wherein the agent incentive is at least one of a fee or a first percentage of the purchase price;
calculating a rebate amount, wherein the rebate amount is a function of the determining step and the transaction data; and
providing the rebate amount to a user.

13. The method for determining a rebate amount in a real estate purchase transaction of claim 12, wherein the rebate amount is at least one of a second percentage of the purchase price or a monetary amount.

14. The method for determining a rebate amount in a real estate purchase transaction of claim 12, wherein the user is an agent associated with the agent incentive.

15. The method for determining a rebate amount in a real estate purchase transaction of claim 12, wherein the agent incentive is reduced by the rebate amount.

16. The method for determining a rebate amount in a real estate purchase transaction of claim 12, the number of thresholds is less than the number of actual or scheduled viewings.

17. The method for determining a rebate amount in a real estate purchase transaction of claim 12, wherein the agent incentive comprises a sales commission.

18. A computer readable medium having computer executable instructions for performing the computer-implementable method for determining a rebate amount in a real estate purchase transaction, wherein a purchased property has a purchase price and an agent incentive of claim 12.

19. A computer system adapted to perform the computer-implementable method for determining a rebate amount in a real estate purchase transaction, wherein a purchased property has a purchase price and an agent incentive of claim 12.

20. A method for determining a rebate amount in a real estate purchase transaction, wherein a purchased property has a purchase price and an agent incentive, the method comprising the steps of:
receiving a plurality of viewing requests;
counting a number of actual or scheduled viewings, wherein the actual or scheduled viewings are initiated by one of the plurality of viewing requests;
determining when the number of actual or scheduled viewings reaches one of a plurality of thresholds, wherein each of the plurality of thresholds corresponds to a different predetermined number of actual or scheduled viewings, wherein the number of thresholds is less than the number of actual or scheduled viewings;
receiving transaction data, wherein the transaction data comprises at least one of a purchase price or an agent incentive, wherein the agent incentive is at least one of a fee or a first percentage of the purchase price;
calculating a rebate amount, wherein the rebate amount:
is a function of the determining step and the transaction data,
is at least one of a second percentage of the purchase price or a monetary amount;
reducing the agent incentive by the rebate amount; and
providing the rebate amount to a user, wherein the user is an agent associated with the agent incentive.
